(19) United States
(12) Patent Application Publication
(10) Pub. No.: US 2015/0003098 A1
(43) Pub. Date: Jan. 1, 2015

(54) Illumination Device of a Motor Vehicle

(71) Applicant: Daimler AG, Stuttgart (DE)

(72) Inventor: Alexis Bony, Sindelfingen (DE)

(73) Assignee: Daimier AG, Stuttgart (DE)

(21) Appl. No.: 14/377,036

(22) PCT Filed: Jan. 10, 2013
(86) PCT No.: PCT/EP2013/000053

§ 371 Date: Aug. 6, 2014

(30) Foreign Application Priority Data
Feb. 7, 2012 (DE) 10 2012 002 334.0

(51) Int. Cl. F21S 8/10

(52) U.S. Cl. CPC F21S 48/1388; F21S 48/1394
USPC 362/517; 362/509; 362/516

(57) ABSTRACT

An illumination device of a motor vehicle has a lamp module formed from at least one light source unit, which includes at least one light source that emits a light radiation to generate a running light distribution. An optical component deflects a part of the emitted light radiation in such a way that a depiction of the at least one light source unit is able to be generated outside of the running light distribution.

### BACKGROUND AND SUMMARY OF THE INVENTION

Exemplary embodiments of the invention relate to an illumination device of a motor vehicle.

Known illumination devices for motor vehicles can be used, among other things, as indicators, brake lights, dipped lights, rear lights, daytime running lights, front headlights etc. Therein, in particular, illumination devices having light-emitting diodes (LED), for example so-called LED headlights, are used more and more frequently, wherein conventionally there is differentiation between so-called resolved and unresolved vehicle headlights. In the case of resolved vehicle headlights, light-emitting diodes are used which comprise several light sources, wherein each of the light sources has an optical system, for example a lens or reflector. Thus, each light source contributes individually to the generation of a running light distribution of the motor vehicle. A conventional number of light sources for resolved vehicle headlights lies between five and ten. In the case of unresolved vehicle headlights, a running light distribution is generated by means of a single technical lighting system. Therein, an LED having several illuminating chips (=LED chips) is used as a light source. Resolved vehicle headlights are, however, also known that use light-emitting diodes with several chips.

Light-emitting diodes with several LED chips have the property that these can malfunction both with the occurrence of a so-called open load (i.e, due to interruption of the electrical circuit) and also in the case of a short circuit. In the case of a short circuit, an increased current flows through the remaining, i.e. still-intact, LED chips, which leads to inefficient performance and thus to a reduced life span. In particular in the case of LED chips connected in series, which is advantageous for energy-efficiency reasons, the electrical malfunction recognition is complicated in the case of a malfunction of one of the LED chips due to a short circuit by analysis of current or voltage due to component tolerances.

Different approaches are known from prior art for recognizing the malfunction of LED chips connected in series.

German patent document DE 10 2009 006 250 A1 discloses an electro-optical light source having an LED chip, wherein the light source comprises a light sensor allocated to the LED chip. Furthermore, an illumination system is described, which comprises the electro-optical light source having an LED chip and a light sensor, wherein the illumination system comprises an operating device that co-operates with the electro-optical light source and which controls the LED chip and evaluates the signal of the light sensor. Additionally, a method is described for monitoring an electro-optical light source having an LED chip and a light sensor having the steps of—applying light sensors with light of the LED chips,—evaluating the signal of the light sensor,—monitoring the function of the LED chip by means of this evaluation.

Furthermore, German patent document DE 10 2009 029 909 A1 describes a method for malfunction recognition of light-emitting diodes in a vehicle, wherein a status variable of a light-emitting diode branch having at least one light-emitting diode is compared to a comparison value and, depending on this comparison, a malfunction recognition signal is generated, wherein a branch current flowing through the light-emitting diode branch is detected as a status variable and a malfunction recognition signal is generated as soon as the branch current falls below the comparison value. Furthermore, when switching on the light-emitting diode branch, the comparison of the status variable to the comparison value is first enabled as soon as a flux voltage is present at least at one light-emitting diode.

German patent application DE 195 26 023 A1 discloses a headlight for a motor vehicle having a light source, a reflector and at least one contour-generating depiction unit to generate defined light/dark boundaries. A device for the at least partial deflection and removal of these light beam bundles is allocated to the depiction unit in the beam path of light beam bundles reflected by the reflector onto the depiction unit. The de-coupled light beam bundles meet at a lens or a corresponding lens system, using which a secondary beam path is achieved, which is able to be used as a fog light or a full beam light.

German patent application DE 10 2004 009 790 A1 discloses a vehicle lighting system having a running light region for the generation of a dipped light and/or a full beam light and a side marker light region for the generation of a side marker light. The light system removes a part of the light radiation generating in the running right region from the running light region and introduces it into the side marker light region.

German patent DE 101 15 868 B4 discloses a headlight unit of a motor vehicle having a headlight with a reflector and a light source for the generation of a dipped light, having a further headlight with a reflector and a light source for the generation of another light function and having means for generating a side marker light, in that light emitted by a light source is reflected by the reflector of the headlight serving for the generation of the other light function. At least one light guiding element is provided, into which light escapes at the headlight serving for the generation of the other light function and is reflected by the reflector thereof for the generation of the side marker light, wherein light is introduced into the at least one light guiding element via an additional reflector, which is not detected by the reflector of the headlight serving for the generation of the dipped light, and wherein the additional reflector has a focal point F1 in the region of the illuminant of the light source and a second focal point F2 in the region of the light entry surface.

German patent DE 31 42 475 C2 discloses a vehicle light for two-wheeled vehicles having a housing and a lamp positioned in a lamp holder that is arranged inside the contour of a reflector, as well as having a lens to cover the reflector and the housing, in the case of which the reflector consists of a hollow body that is hermetically sealed by the lens, and an indentation that is at least partially permeable for light protrudes into the reflector hollow body, which forms a space that is only open outwards to receive the lamp, wherein reflector hollow body and indentation are produced from one piece made from see-through plastic having an applied reflective layer. The indentation is provided with optics, which comprise at least one lens, which acts in the main light radiation direction.

Optical elements are provided at the indentation, which deflect a part of the light radiation emitted from the lamp and throw it onto a window provided in the reflective surface of the reflective hollow body. The regions of the window are covered during the application of the reflective layer, whereby a possibility to pass through is created for light beams such that, for example, light strength distributions that are also required perpendicular to the main light radiation direction can be fulfilled.

U.S. Pat. No. 3,569,933 A discloses a display device that displays to the driver the operational state of a lamp. For this purpose, a part of the light emitted by the lamp is guided to respective display belonging to the lamp with the help of a light conductor.

Exemplary embodiments of the invention are directed to an improved illumination device of a motor vehicle having integrated malfunction recognition compared to the prior art.

An illumination device of a motor vehicle comprises at least one lighting module, formed from at least one light source unit, wherein the light source unit comprises at least one light source and wherein light radiation is able to be emitted for the generation of the driving light distribution by means of the at least one light source. The lamp module is preferably able to be inserted into a vehicle headlight, in particular into a vehicle front headlight.

According to the invention, an optical component is provided, by means of which a part of the emitted light radiation is able to be deflected in such a way that a depiction of the at least one light source unit is able to be generated outside of the running light distribution. For this purpose, the depiction of the at least one light source unit has number of light surfaces corresponding to a number of light sources arranged in the light source unit.

Preferably, a simple monitoring of the light source unit and thus a reliable malfunction recognition of individual light sources arranged in the light source unit is possible by means of the light surfaces represented in the depiction. For example, the light source unit consists of a carrier plate, on which four light sources, for example light-emitting diode chips, are arranged, as is known in the case of vehicle headlights for dipped headlight functions. Provided that all four light-emitting diode chips are activated and intact, i.e. emit light radiation with corresponding current supply, these are depicted in the form of, for example, light points outside of the running light distribution by means of the optical component. In other words, a part of the light radiation emitted by means of the light source is deflected respectively at an angle dependent on the angle of incidence by means of the optical component. Thus, different light surfaces are able to be depicted on the surface of the optical component, which are able to be detected by means of the different angles of incidence and thus the exit angle of the light radiation. Thus, in the case of malfunction, for example of a light-emitting diode chip, only three light points are able to be detected by an observer. Therein, the order of the arrangement of the light points corresponds to the order of the arrangement of the light-emitting diode chips on the carrier plate. An observer is thus able to detect the light points visually from the determined angle without the driving light distribution being masked by the light radiation and thus is able to draw conclusions about a potential malfunction of one or several light-emitting diode chips. The defective light source or even the light source unit can be exchanged as a whole. In the case of this malfunction recognition method, elaborate circuitry or test instruments can thus be dispensed with and it is very cost-efficient.

For a reliable representation of the depiction of the light source unit outside of the running light distribution, a radiation direction of a light radiation reflected by means of the optical component deviates from a main radiation direction of the lamp module. In the case of a use of a lamp module in a vehicle front headlight, the main radiation direction is a direction fundamentally pointing in the direction of travel of the motor vehicle.

In a preferred embodiment of the invention, a further optical component is provided, by means of which the emitted light radiation is deflected to generate the running light distribution.

Preferably, the optical component is arranged at one end of the further optical component, which faces the center of the vehicle, wherein the center of the vehicle is relative to the longitudinal alignment of the motor vehicle. Thus the optical component serves as an extension of the further optical component, wherein the depiction of the light source unit is able to be well detected laterally by an observer, without him being dazzled by the running light distribution. Alternatively or additionally, it is also possible to arrange the optical component laterally alongside the further optical component in the direction of the center of the vehicle, relative to the longitudinal alignment of the vehicle.

Preferably, the further optical component is arranged after the light source unit in the main radiation direction, wherein the optical components are formed respectively as a component that changes the beam path.

In a preferred embodiment, the further optical component is a first reflector, which is formed, for example, as a half shell for as a semi-circle. Such an arrangement of the first reflector as well as the surface condition thereof enables a reflection of the emitted light radiation in the main radiation direction of the lamp module.

In a further preferred embodiment, the optical component is a second reflector having a coating that reduces the light output. This enables an optically comfortable viewing of the depiction of the light source unit without a danger of dazzling existing for the observer.

Therein, the dimensions of a surface of the first reflector are larger in comparison to the dimensions of a surface of the second reflector, such that only a comparably smaller part of the emitted light radiation strikes the second reflector and thus is used to recognize the malfunction of individual light sources. For the running light distribution, enough light radiation is thus still present, such that no additional light sources are needed for the malfunction recognition.

### BRIEF DESCRIPTION OF THE DRAWING FIGURES

Exemplary embodiments of the invention are illustrated in greater detail by means of drawings.

Here are shown:

FIG. 1 schematically, a top view of a lamp module of an illumination device comprising a light source unit, a first optical component and a second optical component,

FIG. 2 schematically, a top view of an illumination device having a lamp module according to FIG. 1, and

FIG. 3 schematically, a perspective top view of the lamp module according to FIGS. 1 and 2.

Parts that correspond to one another are provided with the same reference numerals in all figures.

### DETAILED DESCRIPTION

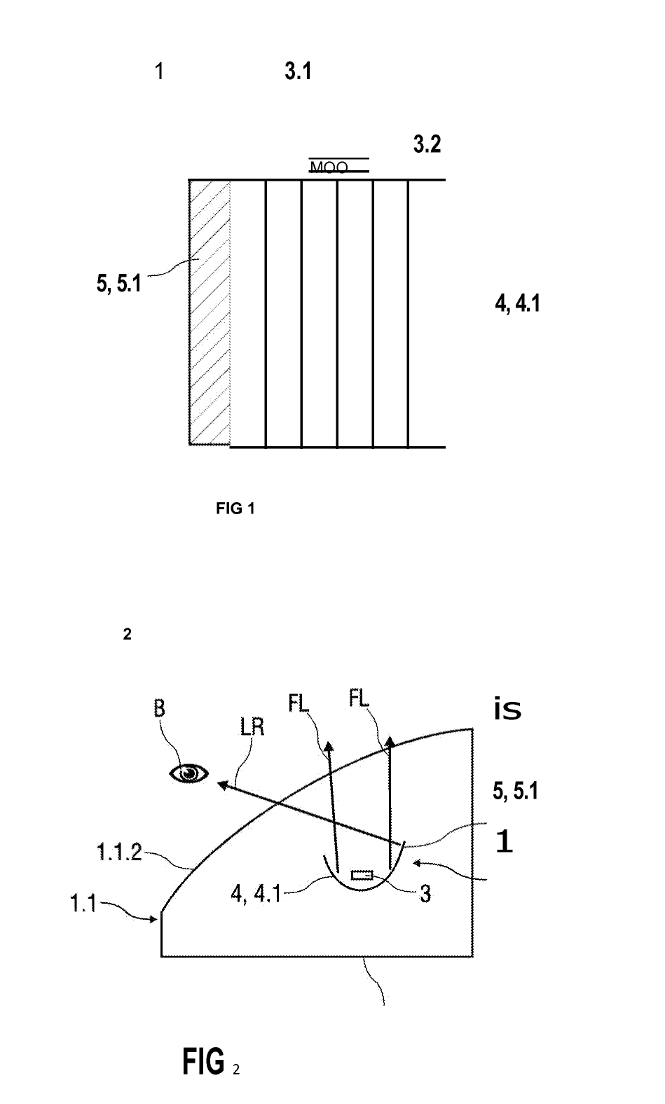

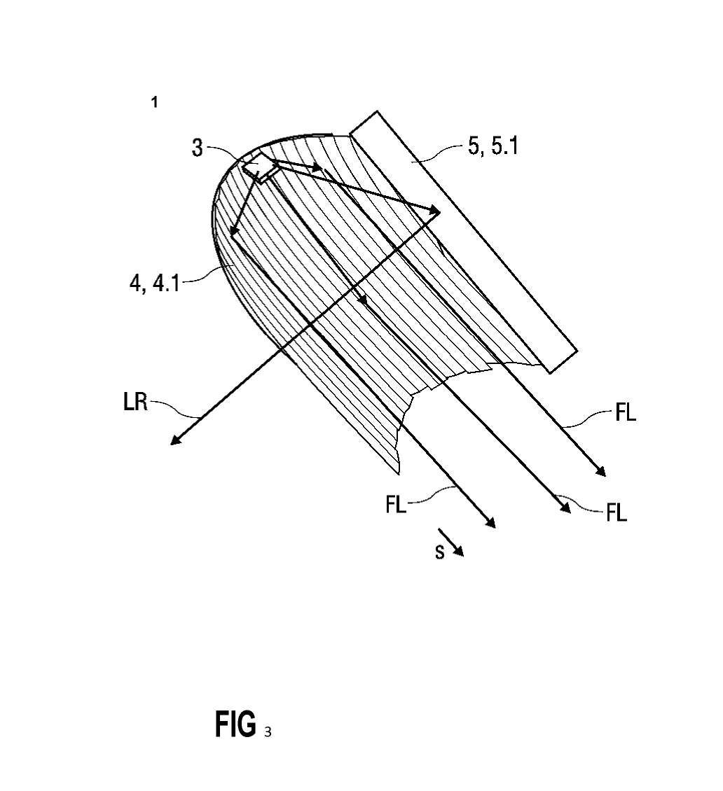

FIGS. 1 to 3 show a lamp module 1 of an illumination device 2 for a motor vehicle that is not depicted in more detail here, wherein the lamp module 1 is formed from a light source unit 3, a first optical component 4 and a second optical component 5. Therein, FIG. 1 shows a schematic and FIG. 3 shows a perspective top view of the lamp module 1 and FIG. 2 shows a schematic top view of the illumination device 2.

The lamp module 1 generates a running light distribution FL for a motor vehicle, such as, for example, dipped light, full beam light, fog light, static or dynamic cornering light, country road light, motorway light, city light, rain or snow light, daytime running light, parking light, side marker light and/or position light.

For this purpose, the lamp module 1 is integrated into the illumination device 2, which, in the sense of the invention, is embodied as a vehicle headlight, referred to below as a vehicle headlight 1.1.

Motor vehicles conventionally comprise two vehicle headlights 1.1, which are arranged laterally in a front region of the motor vehicle.

A vehicle headlight 1.1 comprises a housing 1.1.1, the lamp module 1 and an optically transparent cover disc 1.1.2 which, together with the housing 1.1.1, encloses the lamp module 1 and thus protects this in particular from the effects of weather. Alternatively, several lamp modules 1 are also able to be arranged inside the housing 1.1.1, which are subdivided by their own respective cover discs (not depicted).

To generate the running light distribution FL of the lamp module referred to above, this comprises the light source unit 3, which is formed, in the present exemplary embodiment, from a carrier plate 3.1 and four light sources 3.2.

The light sources 3.2 are arranged next to one another on the carrier plate 3.1 and preferably are in contact with one another electrically in series. Alternatively, an electrical parallel connection of the light sources 3.2 is also possible.

To control the light sources 3.2, the motor vehicle comprises a control unit, for example a headlight control device, which supplies the light sources 3.2 with a current corresponding to the nominal current of the light sources 3.2.

The light sources 3.2 are implemented, in a preferred exemplary embodiment of the invention, as light-emitting diode chips, which in operation, i.e. in the case of corresponding current feed, generate light radiation. Here a light-emitting diode chip is understood to be a p- and n-type semiconductor material, by means of which a so-called pn-transfer is able to be implemented. If a voltage is present at the semiconductor material in the forward direction, the electrons travel from the n-type side to the p-type side, wherein the electrons therein switch to a lower energy level and release energy for the emission of light.

Alternatively or additionally, it is also possible to provide the light-emitting diode chips with a layer or layer series, which preferably is applied directly to the type of semiconductor material. The layer or layer series comprises, for example, luminescence conversion material, which converts a part of the light radiation emitted by means of the type of semiconductor material in light radiation with a varying wavelength, such that a light radiation results with mixed wavelengths. The light radiation then contains, for example, blue and yellow spectral portions, which is experienced as white light by an observer B (depicted as eyes in FIG. 2). Such light-emitting diode chips are referred to as thin film light-emitting diode chips and are suited for use in vehicle headlights 1.1 due to their characteristics as virtual Lambert radiators.

Alternatively, the light sources 3.2 can also be incandescent lamps or gas discharge lamps.

To reduce the divergence of the emitted light radiation described above, the first optical component 4 is subordinated by the light source unit 3 in the main radiation direction s of the lamp module 1. The main radiation direction s of the lamp module 1 is defined in the present exemplary embodiment as a direction fundamentally pointing in the direction of travel.

The first optical component 4 is preferably formed as a first reflector 4.1, which is formed, in the present exemplary embodiment, as a half shell formed as a semi-circle and the incident light radiation is deflected in the main radiation direction s of the lamp module 1, such that a desired vehicle light distribution FL results. For this purpose, the first reflector 4.1 has a reflective surface having a structure formed to be facetted.

In an alternative embodiment, the first reflector 4.1 is formed to be shaped like the frustum of a pyramid and/or frustum of a cone. Therein the first reflector 4.1 can also be formed as a full body consisting of a dielectric material, such as, for example, glass. For this purpose, the full body has a light entry opening and light exit opening. Furthermore, it is also possible that the cover disc 1.1.2 and/or the housing 1.1.1 form the first reflector 4.1 or the first reflector 4.1 is part of the housing 1.1.1. The second optical component 5 is provided for the malfunction recognition of one or several of the hitherto described light sources 3.2, the second optical component 5 being, in the present exemplary embodiment, a flatly formed, second reflector 5.1.

The second reflector 5.1 is arranged at one end of the first reflector 4.1, which faces towards the center of the vehicle, wherein the center of the vehicle is relative to the longitudinal alignment of the motor vehicle. Thus, the second reflector 5.1 forms an additional reflective surface of the first reflector 4.1.

Preferably, the second reflector 5.1 lies laterally at the edge of the first reflector 4.1, such that, due to the Lambert radiation characteristics of the light source 3.2, only a small part of the light radiation emitted by means of the light source 3.2 strikes the second reflector 5.1.

The reflective surface of the second reflector 5.1 is thereby small in comparison to the reflective surface of the first reflector 4.1, such that only a small part of the light radiation emitted by means of the light source 3.2 strikes the second reflector 5.1. Thus, preferably, only a small part of the emitted light radiation is used for the malfunction recognition of individual light sources 3.2, such that an optical appearance of the running light distribution FL is not or at least hardly influenced.

Furthermore, the second reflector 5.1 has a coating or a surface treatment, which reduces the light output. Preferably the coating or the surface treatment is at least partially light-absorbent, such that the light radiation striking the second reflector 5.1 is only partially reflected. Lacquer, plastic, semiconductors are, for example, suitable as a light-absorbent coating or for the surface treatment. Alternatively, other coating materials, which have expediently a dark color perception, for example black, are suitable.

Alternatively, the second reflector 5.1 can be produced from an at least partially light-absorbent material, preferably darkly colored, partially reflective. An example of this is plastic which expediently has a dark color, such as black acrylonitrile butadiene styrene copolymer polycarbonate (ABS-PC).

In an alternative embodiment, the second reflector 5.1 has at least one optical depiction unit, which collects light radiation striking the second reflector 5.1 and deflects only a part of the light radiation accordingly. The optical depiction unit can, for example, consist of one or several collecting lenses or of achromats or of a combination of collecting lenses and achromats.

The light radiation striking the second reflector 5.1 is deflected in one direction due to the arrangement of the second reflector 5.1 described above, which deviates from the main radiation direction s of the lamp module 1 and which points towards the center of the vehicle. Thus, the light radiation LR reflected by means of the second reflector 5.1 is optically detectable for the observer B outside of the running light distribution FL without him being blinded by the running light distribution FL.

Due to the surface condition of the second reflector 5.1, the light radiation is reflected depending on the angle of incidence. In other words, the light source unit 3 has, in the present exemplary embodiment, four light sources 3.2 that are arranged next to one another; thus the reflected light radiation LR comprises at least four radiation bundles that are at a distance to one another. For example, the light sources 3.2 are arranged next to one another along an axis, which runs parallel to the vehicle transverse axis. In other words: From the view of the observer B, the light sources 3.2 are arranged next to one another on the carrier plate 3.1 from left to right. The radiation bundles of the reflected light radiation LR are then arranged next to one another along an axis, which runs parallel to the vehicle vertical axis, so according to the observer B, from above to below.

The individual radiation bundles have correspondingly different exit angles depending on the arrangement of the light sources 3.2, such that these are detectable as virtual light sources in the form of a light point. Thus, four light points are visually detectable for the observer B outside of the running light distribution FL on the surface of the second reflector 5.1, if all light sources 3.2 are intact.

For the optimal observation of these light points, the observer B, for example workshop personnel, is positioned at a specific angle to the main radiation direction s of the light module 1, so laterally in front of the motor vehicle and thus laterally in front of the motor vehicle headlights 1.1 (see FIG. 2).

Using the at least partially light-absorbent coating or surface treatment of the second reflector 5.1, a safety of the observer B is increased, as an intensity of the reflected light radiation LR is reduced by contrast with the light radiation striking the second reflector 5.1. The observer B can therefore observe the reflected light radiation LR without effort and/or risk of dazzling.

If, for example, one of the lamp modules 1 is defective, i.e. the lamp module 1 does not emit any light radiation despite corresponding current supply, then only three light points are detectable for the observer B. The observer B knows which light source 3.2 is defective by the fact that the arrangement of the light points at a distance to one another corresponds to the arrangement of the lamp modules 1 in the light source unit 3. A malfunction of the light source 3.2 is above all able to occur in the embodiment as a light-emitting diode chip during the occurrence of a so-called open load, so by interrupting the circuit, and also in the case of a short circuit. In particular in the case of a short circuit, an increased current flows through the remaining, i.e. still intact, light-emitting diode chips, which leads to an inefficient performance and thus to a reduced service life of the light source units 3.

Thus, a reliable malfunction definition of the light sources 3.2 with only one additional component is possible, wherein electronic elaborate electronic connections or electro-optical devices can be dispensed with. This is particularly advantageous if an array of light source units 3 is arranged in the lamp module 1.

Additionally it is possible to monitor the light sources 3.2 continually. If the intensity of the emitted light radiation is reduced due to ageing of the light source 3.2, then the intensity of the reflected light radiation LR is also reduced, which can be recognized by the intensity reduction of the corresponding light point(s).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof

1-10. (canceled)

11. An illumination device of a motor vehicle, comprising:
a lamp module, which comprises at least one light source unit having a number of light sources, wherein the number of light sources are arranged to emit light radiation of a running light distribution;
an optical component arranged inside the illumination device, wherein the optical component is configured so that a portion of the emitted light radiation is deflected in such a way to generate a depiction of the at least one light source unit outside of the running light distribution, and wherein the depiction of the at least one light source unit has a number of light surfaces corresponding to the number of light sources arranged in the light source unit.

12. The illumination device of claim 11, wherein a radiation direction of a light radiation reflected by the optical component deviates from a main radiation direction of the lamp module.

13. The illumination device of claim 11, comprising:
a further optical component configured to deflect the emitted light radiation to generate the running light distribution.

14. The illumination device of claim 13, wherein the optical component is arranged at one end of the further optical component laterally alongside the further optical component in a direction of a center of the vehicle in such a way that the depiction is detected laterally by an observer.

15. The illumination device of claim 13, wherein the further optical component is subordinate to the light source unit in the main radiation direction.

16. The illumination device of claim 13, wherein the optical component and the further optical component are formed as a construction element that changes a beam path.

17. The illumination device of claim 16, wherein the further optical component is formed as a first reflector.

18. The illumination device of claim 17, wherein the optical component is a second reflector having a coating and increases light output.

19. The illumination device of claim 18, wherein dimensions of a surface of the first reflector are larger than dimensions of a surface of the second reflector.
